(19) United States
(12) Patent Application Publication
(10) Pub. No.: US 2019/0221862 A1
(43) Pub. Date: Jul. 18, 2019

(54) Method of Fabricating Separating Membrane of Flow Battery for Achieving Low Impedance and Low Permeability

(71) Applicant: Institute of Nuclear Energy Research, Atomic Energy Council, Executive Yuan, R.O.C., Taoyuan (TW)

(72) Inventors: Chien-Hong Lin, Taoyuan (TW); Ming-Chien Yang, Taoyuan (TW); Hwa-Jou Wei, Taoyuan (TW)

(21) Appl. No.: 16/142,001

(22) Filed: Sep. 26, 2018

(30) Foreign Application Priority Data
Jan. 18, 2018 (TW) 107101854

(51) Int. Cl. H01M 8/0245; H01M 8/0239; H01M 8/18; B05D 3/14

(52) U.S. Cl. CPC H01M 8/0245; B05D 3/144; H01M 8/188; H01M 8/0239

(57) ABSTRACT

A method is provided to fabricate a Nafion separating membrane for achieving low impedance and low permeability. Sodium 4-styrenesulfonate (NASS) is grafted to the surface of the membrane through an oxygen plasma induced grafting technique. A modified Nafion-g-NASS membrane is thus fabricated for a vanadium redox flow battery (VRFB) with the permeability of vanadium ions reduced and the conductivity of protons improved. The modified membrane shows higher ion exchange capacity and permeating conductivity along with enhanced voltage efficiency (VE), coulombic efficiency (CE) and energy efficiency (EE). Due to the low permeability of vanadium ions, the VRFB with the modified membrane shows slower self-discharge than that with the pristine Nafion membrane. After 200 cycles of charging and discharging, the VE, CE and EE remain stable. In particular, the modified VRFB shows a higher rate of capacity retention than the pristine VRFB.

### TECHNICAL FIELD OF THE INVENTION

The present invention relates to fabricating a separating membrane of a flow battery; more particularly, to growing sulfonates (SO₃⁻) on the surface of the separating membrane through an oxygen plasma induced grafting technique, where the permeation of vanadium ions is reduced along with the conductivity of protons improved.

### DESCRIPTION OF THE RELATED ARTS

The generation of solar power and wind power are unstable, not to mention the problem of intermittent power supply. Hence, an energy storage is required to reduce the impact of grid-connected renewable energies for increasing the stability of the power grid. Besides, the grid peak load can be thus adjusted to maintain the balance of power supply. In a number of power storage technologies, there are two main categories: The first category are physical energy storages, including the use of storing energy through keeping water (e.g. hydroelectric power) and through compressing air (e.g. wind power). The second category are chemical energy storages, including various secondary batteries like lithium ion batteries, nickel hydrogen batteries, flow batteries, etc.

The energy storages for supporting transmission, distribution and peak-shaving of the grid are mostly chemical energy storages. Therefore, in the large-scale energy storages, most of them are lead-acid batteries and flow batteries. Therein, as compared to other energy storages, the flow batteries chemically storing energy have advantages of power dimensioning flexibility, safe utilities, long cycle life, and long discharge time, etc., which gradually becomes a research focus.

Regarding the energy storage technologies, the vanadium redox flow battery (VRFB) has obvious advantages, including:

1. Flexible design: The power and the capacity are independent, where the power depends on the size of the power cell stack and the capacity depends on the size of the electrolytic solution.

2. Long life: Vanadium is a stable element, so that the battery can have an extremely long life.

3. Large power: By increasing the number of single cells and the electrode area, the power of the VRFB can be increased.

4. Fast starting: When the battery stack is full of electrolyte, the VRFB can be started within 2 minutes.

5. High safety: VRFB has no potential explosion hazard.

6. Instantaneous charge: By replacing the electrolyte, VRFB can be instantly charged, very convenient.

Thus, using VRFB along with solar and wind power generator, a stable supply of electricity can be guaranteed.

All-VRFB energy storage charges and discharges power by using a redox reaction between the positive and negative electrodes. The positive electrode has tetravalent vanadium (V⁴⁺) and pentavalent vanadium (V⁵⁺); and the negative electrode has divalent vanadium (V²⁺) and trivalent vanadium (V³⁺). The four valences of vanadium ions can be stably existed, and high stability is therefore obtained with high safety and long life.

The key materials of a flow battery include separating membrane, electrode and electrolyte. Therein, the functions of the separating membrane include separating the positive and negative electrolytes to prevent short-circuit; and conducting protons (H⁺) to balance positive and negative charges and form battery circuit.

The most used membranes in VRFB are Dupont's Nafion membranes. Nafion is a cation-exchange polymer with stable Teflon backbone and sulfonic side groups. It possesses high chemical stability and high proton conductivity. However, Nafion membranes are expensive while exhibiting high vanadium ion permeability. Nafion membrane accounts for 40% of the total cost of a VRFB cell stack. The Nafion membrane has sulfonate (SO₃⁻) and holes will be formed in an aqueous solution through hydration, where vanadium ions and protons are transferred through the holes. The selectivity to vanadium ions and protons is not high for the Nafion membrane, which further leads to produce cross-permeability of vanadium ions between the positive and negative electrodes during charging and discharging the VRFB. This is the main factor which results in reduced energy efficiency and affects battery life. Therefore, the study of membrane to obtain low vanadium ion permeability is necessary.

Since the Nafion membrane has sulfonate with holes formed in the aqueous solution through hydration and with vanadium ions and protons transferred through the holes, the protons obtain good conductivity yet the permeability of the vanadium ions is also high. The high permeability of the vanadium ions reduces the coulombic efficiency (CE) and the energy efficiency (EE) of the VRFB, and the battery life is thus shortened. Thus, Nafion limits the broad commercialization of VRFB.

It is thus clear that the holes of the conventional separating membrane make vanadium ions and protons pass through the positive and negative electrolytic solutions simultaneously. As a result, the goals for decreasing vanadium ion permeability and increasing proton conductivity are conflicting. Hence, the prior arts do not fulfill all users' requests on actual use.

### SUMMARY OF THE INVENTION

The main purpose of the present invention is to modify the surface of a separating membrane through an oxygen plasma induced grafting technique and reduce the permeability of vanadium ions while the conductivity of protons is improved through the simple modification.

Another purpose of the present invention is to graft sodium 4-styrenesulfonate (NASS) to a Nafion membrane through in situ copolymerization in the oxygen plasma modification, where sulfonates are grown on the surface of the Nafion membrane; and sulfonates block the holes of the Nafion membrane to stop vanadium ions having bigger sizes from permeating through the Nafion membrane.

Another purpose of the present invention is to obtain high hydrophilicity and ion exchange capacity (IEC) by grafting NASS for improving the performance of the VRFB with the modified Nafion-g-NASS membrane.

To achieve the above purposes, The present invention is a method of fabricating a separating membrane of a flow battery for achieving low impedance and low permeability, comprising steps of pretreatment of separating membrane; oxygen-plasma activation; and grafting of hydrophilic monomer of sodium 4-styrenesulfonate (NASS), where a Nafion membrane is obtained to be processed with a soaking pretreatment; the Nafion membrane is activated through an oxygen-plasma treatment to obtain oxygen radicals on surface of the Nafion membrane; the activated Nafion membrane is immersed in a NASS monomer; copolymerization is processed between the oxygen radicals and the carbon-carbon double bonds of the NASS monomer; a hydrophilic group of sulfonates is grown on the surface of the Nafion membrane; the sulfonates obturate holes of the Nafion membrane; and protons having a smaller size but not vanadium ions having a bigger size pass through the Nafion membrane.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the view showing the grafting of sodium 4-styrenesulfonate (NASS) onto the Nafion membrane;

FIG. 3 is the view showing the plasma modification;

FIG. 4 is the structural view showing the single cell of vanadium redox flow battery (VRFB);

FIG. 5A is the view showing the vanadium (V) ions permeability of the separating membranes used in the VRFB;

FIG. 5B is the view showing the water transport of the separating membranes used in the VRFB;

FIG. 5C is the view showing the stability of the separating membranes used in the VRFB;

FIG. 6A is the view showing the charge-discharge curves of the VRFBs with different membranes at 120 milli-amperes per square centimeter (mA·cm⁻²);

FIG. 6B is the view showing the charge-discharge curves of the VRFBs with different membranes at 160 mA·cm⁻²;

FIG. 6C is the view showing the open-circuit voltage curves of the VRFBs with different membranes;

FIG. 7A is the view showing the effects of current density on the coulombic efficiency (CE) of the VRFBs with different membranes;

FIG. 7B is the view showing the effects of current density on the voltage efficiency (VE) of the VRFBs with different membranes;

FIG. 7C is the view showing the effects of current density on the energy efficiency (EE) of the VRFBs with different membranes;

FIG. 8A is the view showing the cycle performances of the VRFBs with different membranes;

FIG. 8B is the view showing the charge-discharge curve for the VRFB with the Nafion 212 membrane during 200 cycles;

FIG. 8C is the view showing the charge-discharge curve for the VRFB with the Nafion-g-NASS membrane during 200 cycles; and

FIG. 8D is the view showing the discharge capacities of the Nafion 212 and Nafion-g-NASS membranes with respect to cycle number.

### DESCRIPTION OF THE PREFERRED EMBODIMENT

The following description of the preferred embodiment is provided to understand the features and the structures of the present invention.

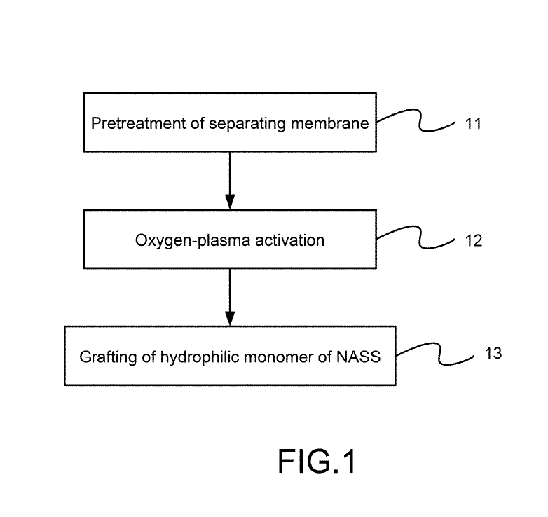

Please refer to FIG. 1 to FIG. 8D, which are a flow view showing a preferred embodiment according to the present invention; a view showing grafting of NASS onto a Nafion membrane; a view showing plasma modification; a structural view showing a single cell of VRFB; views showing vanadium ions permeability, water transport and stability of separating membranes used in the VRFB; views showing charge-discharge curves of the VRFBs with different membranes at 120 mA·cm⁻² and 160 mA·cm⁻² and a view showing open circuit voltage curves of the VRFBs with different membranes; views showing the effects of current density on CE, VE and EE of the VRFBs with different membranes; and a view showing the cycle performances of the VRFBs with different membranes, views showing charge-discharge curves for the VRFB with Nafion 212 and Nafion-g-NASS membranes during 200 cycles and a view showing discharge capacities of the Nafion 212 and Nafion-g-NASS membranes with respect to cycle number. As shown in the figures, the present invention is a method of fabricating a separating membrane of a flow battery for achieving low impedance and low permeability, comprising the following steps:

(a) Pretreatment of separating membrane 11: A Nafion membrane 2 is provided to be processed with a soaking pretreatment.

(b) Oxygen-plasma activation 12: The Nafion membrane 2 is activated through an oxygen-plasma treatment to generate oxygen radicals on the surface of the Nafion membrane 1a.

(c) Grafting of hydrophilic monomer of NASS 13: The activated Nafion membrane 2a is immersed in a NASS monomer. Therein, copolymerization is processed between the oxygen radicals and the carbon-carbon double bonds (C═C) of the NASS monomer; a hydrophilic group of sulfonates (SO₃⁻) is grown on the surface of the Nafion membrane to obtain a Nafion-g-NASS membrane 1b; with more of the sulfonates generated on the surface of the Nafion-g-NASS membrane, protons are conducted with increased conductivity owing to charge attraction, but the sulfonates obturate holes of the Nafion membrane; and, thus, protons having a smaller size pass through the Nafion membrane but vanadium ions having a bigger size are further stopped from being permeated. Thus, a novel method of fabricating a separating membrane of a flow battery for achieving low impedance and low permeability is obtained.

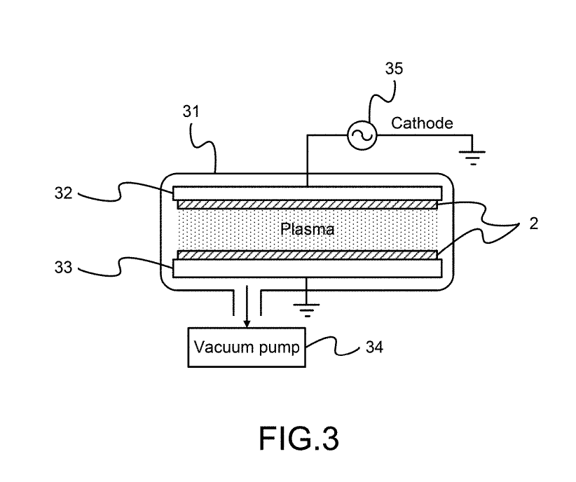

The oxygen-plasma activation is shown in FIG. 3. The Nafion membrane 2 is disposed in a plasma sheath or dark area between upper and lower electrodes 32, 33 in a cavity 31. An end of the cavity 31 is connected to a vacuum pump 34. The upper electrode 32 is connected to a plasma power 35. The lower electrode 33 is grounded. On processing plasma modification with a radiation power of 100 watts (W), an oxygen flow of 2 standard cubic centimeters per minute and an operating time of 90 seconds, ions accelerated in the plasma sheath bombard the Nafion membrane 2 to destroy atom-bonds on the surface to further process chemical reaction with activated particles rapidly for etching.

Along with all the above characteristics, the present invention fabricates the separating membrane whose main effects are clearly presented in the following for illustrating the present invention but not for limiting.

Method

[Graft-Polymerization of NASS]

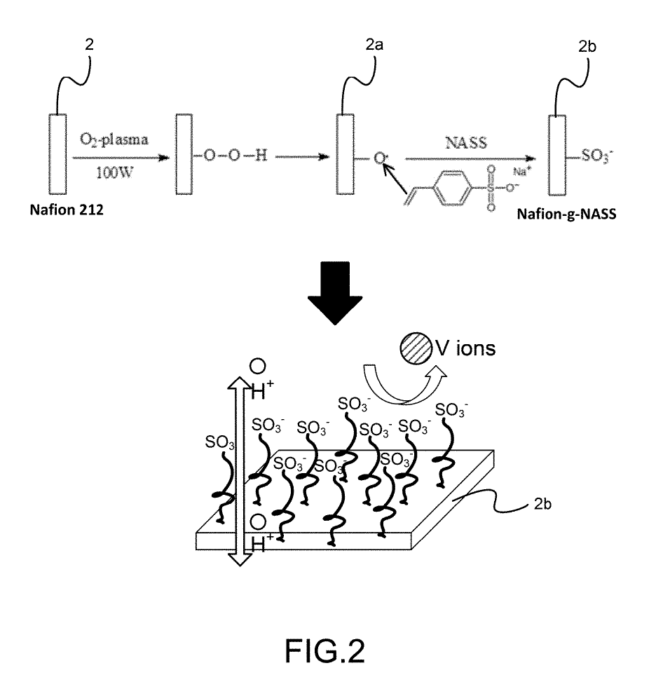

The Nafion membrane used is Nafion 212. In FIG. 2, before modification, the membrane is placed in 3 weight percent (wt %) of H₂O₂ at 80 Celsius degrees (° C.) for 60 minutes (min), followed by being soaked in deionized water at 80° C. for 30 min, and finally, soaked in 1 millimole (mM) of H₂SO₄ at 80° C. for 30 min. Afterwards, the membrane is rinsed with deionized water to remove H₂SO₄. Then, the pretreated Nafion membrane 1 is cut into pieces of 7×7 square centimeters (cm²) followed by being treated with oxygen plasma at 100 W for 6 min. The oxygen flow is fixed at a volume of 25 liters per minute (L·min⁻¹). Afterwards, the activated Nafion membrane 2a is immersed in an N₂-purged glass bottle containing 5 wt % NASS at 70° C. for 24 hours (h) to process graft-polymerization. The NASS-grafted Nafion membrane is rinsed with double-distilled water to remove unreacted monomer. The resultant Nafion-g-NASS membrane 2b is preserved in deionized water for the following tests.

### [Hydrophilicity Test]

The contact angle of the surface of the membrane is measured by using a contact angle goniometer (DSA 100, Krüss GmbH, Hamburg, Germany). The water uptake of the membrane is calculated by using the following formula:

$$water uptake ( \% ) = \frac{{W}_{w} - {W}_{d}}{{W}_{d}} \times 100 \% ,$$

where W_{d} is the weight of a dry sample, and W_{w} is the weight measured after immersing the sample in deionized water for 24 h.

### [Surface Grafting Density]

The surface density of the sulfate groups of NASS is measured by dyeing the membrane with 0.01 gram per milliliter (g·mL⁻¹) of C.I. Basic Blue 17 (Chroma-Gesellschaft GmbH, Munster, Germany) at 30° C. and pH10 for 5 h. Afterwards, adsorbed dye molecules are removed by being rinsed with double-distilled water before being immersed in 0.1 mole (M) of NaOH. Lastly, the membrane is immersed in 50 volume percent (vol %) of acetic acid to desorb associated dye molecules. An absorbance at 633 nanometers (nm) is measured to calculate dye concentration.

### [Determination of Ion Exchange Capacity (IEC)]

The protonated membrane is immersed in 1M of NaCl for 24h to replace H⁺ with Na⁺. Then, the solution was titrated with 0.01 M of NaOH to determine the concentration of exchanged H. The IEC is calculated through the following formula:

$$IEC = \frac{{V}_{NaOH} {C}_{NaOH}}{{m}_{dry}} ,$$

where V_{NaOH} is the titrating volume, C_{NaOH} is the concentration of NaOH (0.01M), and m_{dry} is the dry mass of polymer.

### [Through-Plane Conductivity]

A cell for area resistance test is used to measure the through-plane conductivity of the membrane. Each half-cell contains 50 milliliters (mL) of 1.2M of VOSO₄ in 2.5M of H₂SO₄/3M of HCl. The electrodes are held by an electrode holder at a fixed distance apart and a fixed depth of immersion. Before testing, the membrane is immersed in 1.2M of VOSO₄ in 2M of H₂SO₄/3M of HCl for over 24 h. The conductivities of the membrane are determined by an impedance at an AC amplitude of 0.2 volts (V) over a frequency range of 1 to 106 hertz (Hz) by using a frequency response analyzer (Model 1255B, Solartron Analytical, Leicester, UK). The area resistance of the membrane, R (ohm square centimeter, Ω·cm²), is calculated with the following formula:

R·(R₁−R₂)×A,

where R₁ and R₂ are the resistances (Ω) of the cell with and without the membrane, respectively, and A is the effective membrane area (cm²).

### [Ex-Situ Chemical Stability]

The membrane is cut into pieces (2×4 cm²) and soaked in 20 mL of 0.1M VO₂⁺ in 2.5M of H₂SO₄/3M of HCl. The degradation of the membrane is determined by monitoring the change of the concentration of VO₂⁺ and VO²⁺ in the solution. The absorbance of the solution at 760 nm is periodically determined spectrometrically. The absorbance of the solution is then converted to concentration.

### [Single Cell Construction]

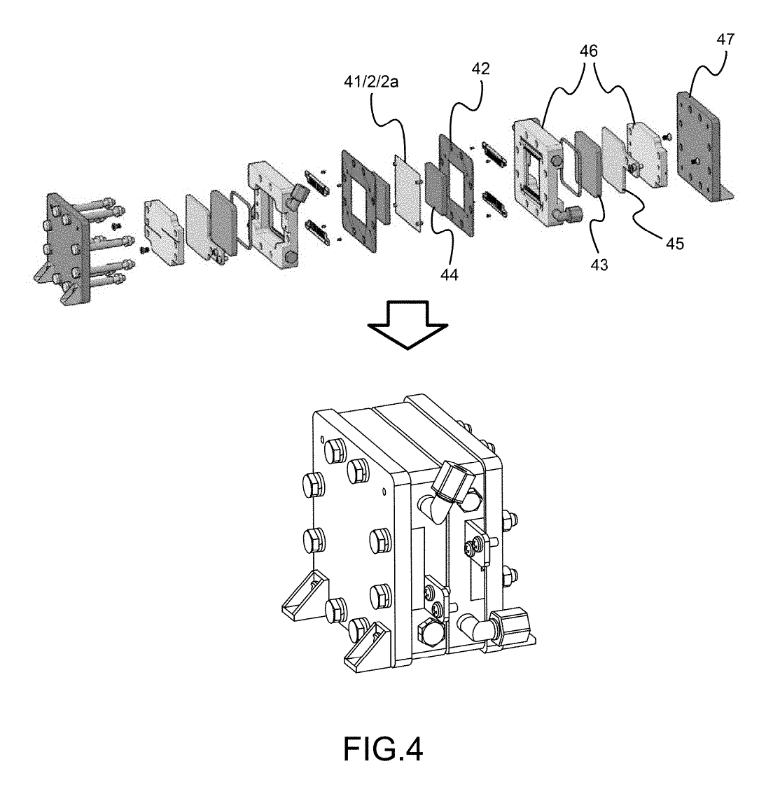

FIG. 4 shows the structure of a single cell, comprising a separating membrane 41, two gaskets 42, two graphite bipolar plates 43, two carbon felts 44, two gold-plated conductive plates 45, two polyvinyl chloride (PVC) plate set 46 and two endplates 47. The separating membrane (5×5 cm²) 41 is clamped by the two gaskets 42 each of which has a thickness of 1 millimeter (mm). The two graphite bipolar plates 43 are used as current collectors. Each of the graphite bipolar plates 43 has an indentation of 6 mm for the flow of electrolytes. The indentation also holds a carbon felt (5×5×0.65 cm³) as electrode. Each of the graphite bipolar plates 43 is respectively assembled with one of the gold-plated conductive plates 45 in the PVC plate set 46. The whole cell is assembled together by the two endplates 47 of stainless steel.

### [VRFB Single Cell Test]

For testing, negative and positive solutions of 1.2M V²⁺/V³⁺ in 2.5M H₂SO₄/3M HCl and 1.2M VO²⁺/VO²⁺ in 2.5M H₂SO₄/3M HCl are prepared, respectively. The volume of each of the solutions is 80 mL. The VRFB single cell is charged and discharged at a current density of 80-180 mA·cm⁻². The VRFB is charged to 1.6V and discharged at 0.8V to avoid corroding the electrodes of carbon felts 44 and the graphite bipolar plates 43. The cycling life test is processed at a current density of 120 mA·cm⁻². The test of self-discharge begins at a state of charge (SOC) of 50% and ends when the voltage is below 0.8V.

Results

### [Characteristics of Membranes]

Table 1 summarizes the characteristics of the Nafion 212 and Nafion-g-NASS membranes. As is shown, the grafting of NASS on the surface of Nafion 212 membrane does not significantly affect the thickness of the membrane. The water uptake of Nafion-g-NASS membrane remains almost unchanged. However, Table 1 shows that Nafion-g-NASS membrane has a lower water contact angle due to the hydrophilic NASS on the exposed surface (the grafting density of the sulfate group is 36.6 nano-moles per square centimeter (nmol·cm⁻²), indicating the surface of Nafion-g-NASS membrane is more hydrophilic. As shown in Table 1, the IEC of Nafion-g-NASS is higher than that of pristine Nafion. In addition, the area resistance of the Nafion-g-NASS membrane is lower than that of the pristine Nafion membrane owing to that the additional free sulfate groups on the surface are beneficial for improving proton conductivity.

TABLE 1

Membrane

| Performance | Nafion | Nafion-g-NASS |
|---|---|---|
| Modified content (wt %) | — | 0.8 |
| Contact angle (°) | 94 | 66 |
| Thickness (μm) | 51 | 52 |
| IEC (mmol · g⁻¹) | 1.12 | 1.28 |
| permeability (wt %) | 45.5 | 46.5 |
| Area resistance (Ω · cm²) | 2.48 | 1.92 |

### [Permeability of Vanadium Ions]

The membrane in a VRFB is used to prevent the cross mixing of vanadium ions in each half cell, which is governed by the permeability of vanadium through the membrane. Thus the membrane must exhibit low permeability of vanadium ions to reduce self-discharge.

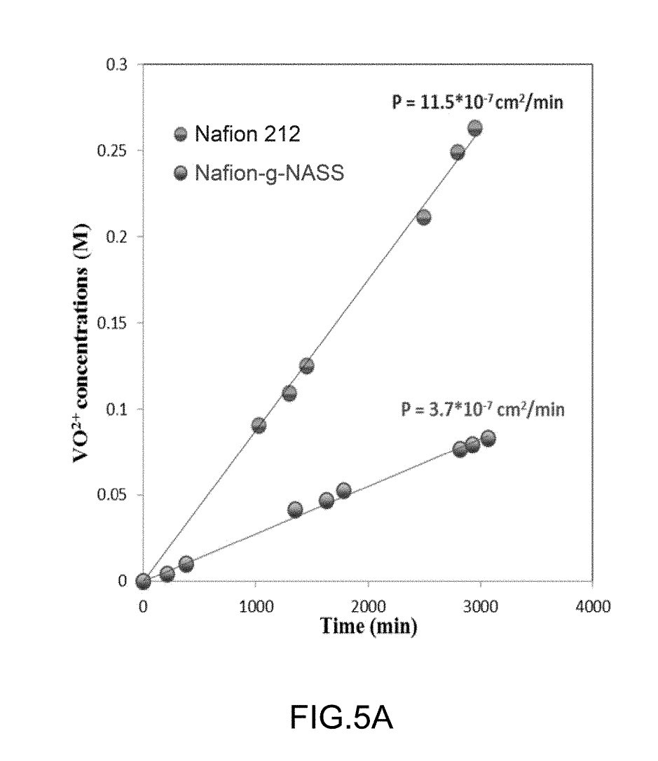

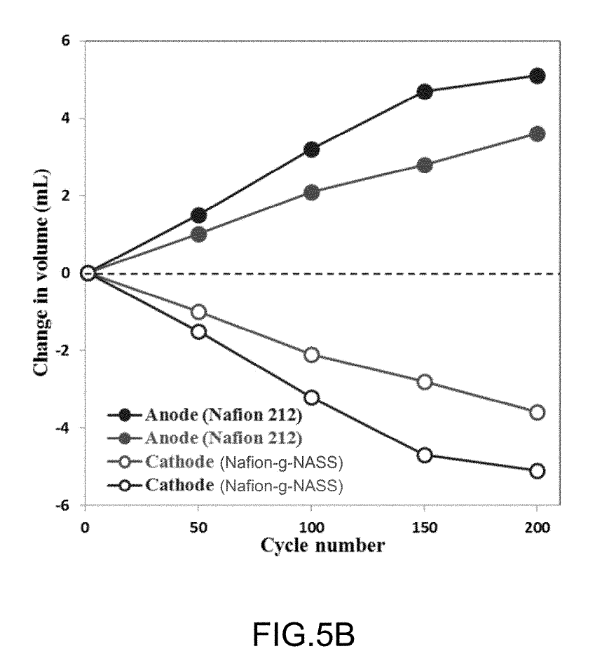

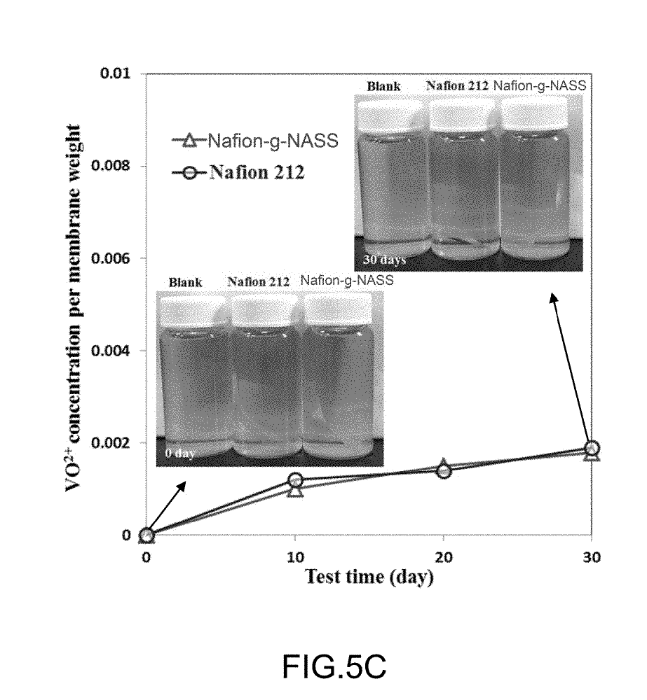

FIG. 5A shows that VO²⁺ can permeate through both Nafion-g-NASS and pristine Nafion 212 membranes. However, the permeation of VO²+ through the Nafion-g-NASS membrane (3.7×10⁻⁷ square centimeters per minute (cm²·min⁻¹)) is only 32% of that through the Nafion 212 membrane (11.5×10⁻⁷ cm²·min⁻¹) under the same conditions. This suggests that the grafting of NASS did decrease the permeability of vanadium ions, probably attributing to the blocking of the pores on the Nafion 212 membrane surface by NASS.

### [Water Transport Measurements]

FIG. 5B shows water transfered from the negative side to the positive side during the charge-discharge cycles of VRFB. This is due to the movement of hydrated vanadium ions. After 200 cycles at 120 mA·cm⁻², the volume of water transferred across the Nafion-g-NASS membrane (3.6 mL) is only 70% of that across the Nafion 212 membrane (5.1 mL). The reduction in the water transfer agrees with the trend of lower permeability to vanadium ions shown in FIG. 5A.

The Nafion-g-NASS membrane exhibits much lower water transport and permeability than the Nafion 212 membrane. Therefore, VRFB/Nafion-g-NASS will show better cell performance than VRFB/Nafion.

### [Chemical Stability of Membranes]

A membrane separator must be chemically stable to maintain the long-term battery performance. The highly oxidative VO₂⁺ ions generated at anode side of a battery during charging can cause the degradation of membrane, which leads to the reduction of VO₂⁺to VO²⁺. Therefore, monitoring the change in VO²⁺ concentration offers useful insights into the stability of the membrane. In the present invention, the membranes are exposed to a VO²⁺ solution (0.1 M VO₂⁺ in 2.5 M H₂SO₄/3M HCl) at room temperature for a maximum of 30 days.

FIG. 5C shows that the VO²⁺ concentration increases slightly in solutions containing the Nafion-g-NASS or Nafion 212 membrane, which indicates that these two membranes degrade at a very low level. In addition, the color of the VO²⁺ solution changes very little after 30 days. Thus, the grafting of NASS does not significantly affect the stability of the membrane.

### [Charge-Discharge Curves]

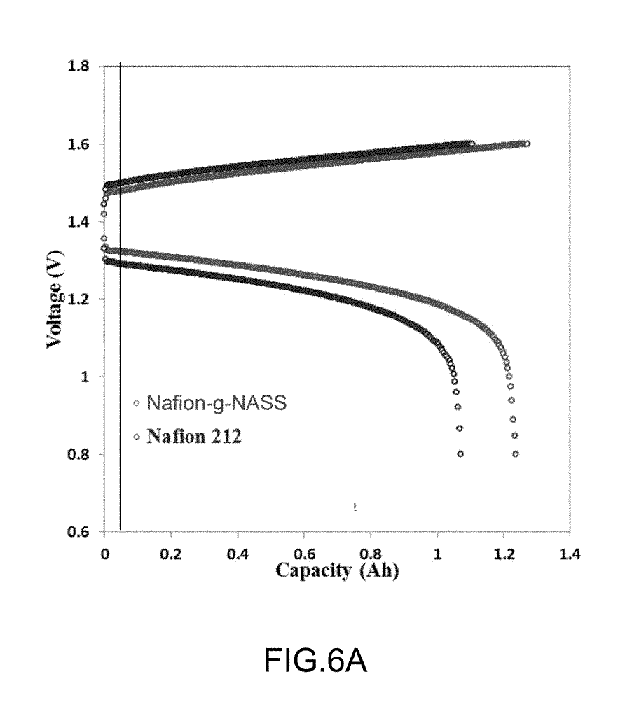

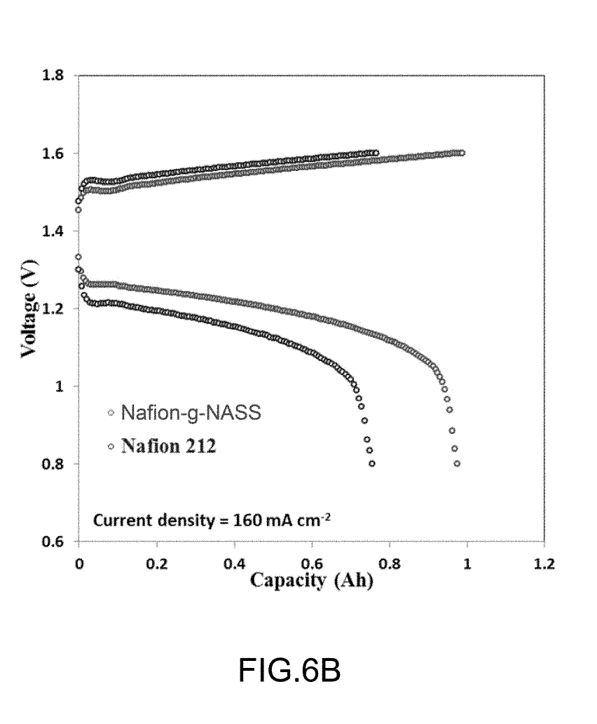

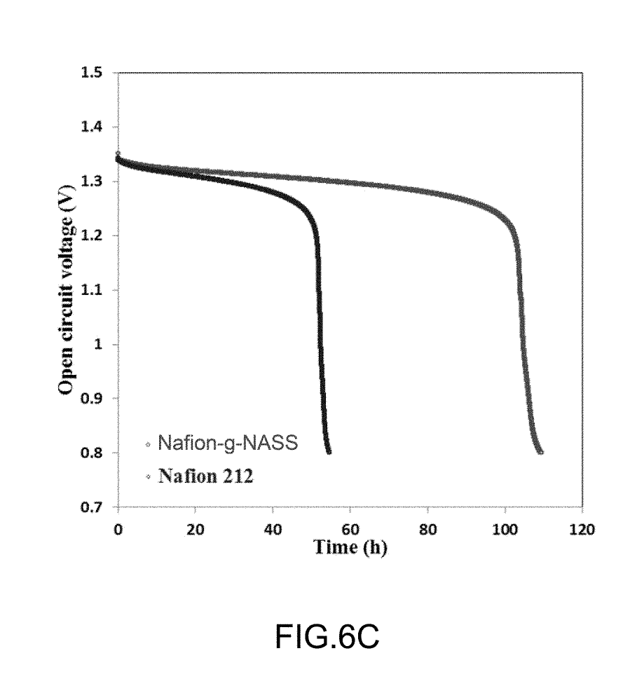

FIG. 6A and FIG. 6B show the charge-discharge curves of a VRFB single cell in a second cycle at 120 and 160 mA·cm⁻², respectively. Comparing to VRFB/Nafion, VRFB/Nafion-g-NASS exhibits lower charge voltage and higher discharge voltage due to the lower area resistance of the Nafion-g-NASS membrane. The figures also show that VRFB/Nafion-g-NASS exhibits higher discharge capacity than VRFB/Nafion at both 120 and 160 mA·cm⁻² because of the lower permeability of vanadium ion through the Nafion-g-NASS membrane. The higher utilization rate of electrolytes in the VRFB/Nafion-g-NASS would increase the battery capacity. The charge-discharge capacity would decrease at higher current densities due to stronger polarization effects. In addition, the self-discharge of the VRFB single cell would decrease with lower permeability for vanadium ions. As a result, the VE and CE of VRFB/Nafion-g-NASS are higher than those of VRFB/Nafion.

### [Open-Circuit Voltage (OCV)]

FIG. 6C shows that the duration of VFRB/Nafion-g-NASS maintained at an OCV above 0.8V is more than 109 h, while that of VRFB/Nafion is only 54 h. The result agrees in vanadium permeability because the decrease in OCV of a VRFB single cell is due to the permeability of vanadium ions through the membrane. Thus VRFB/Nafion-g-NASS exhibits lower self-discharge and higher EE.

### [Performance of VRFB Single Cell-1]

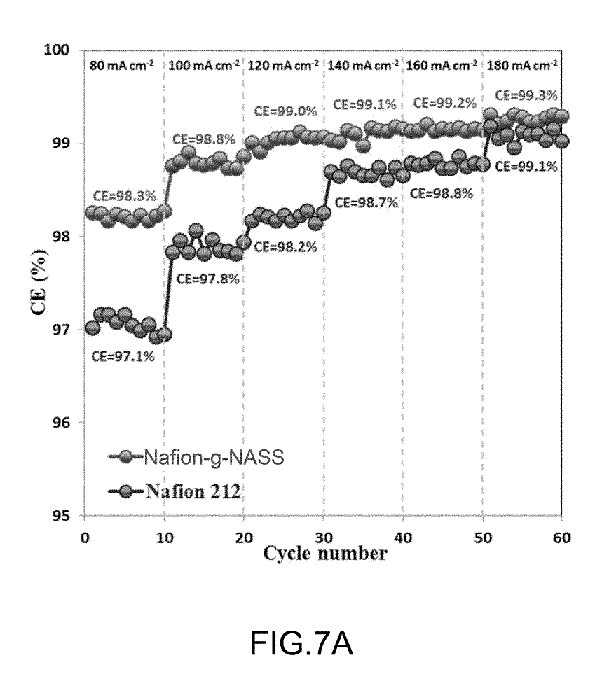

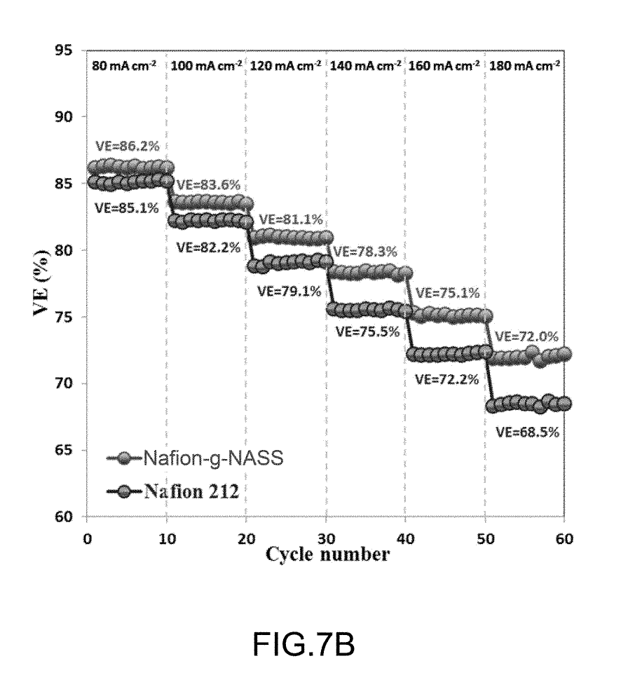

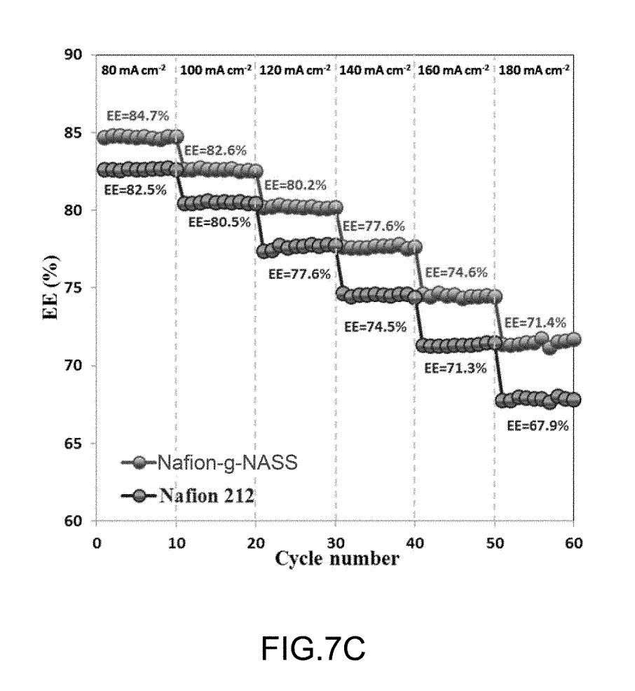

FIG. 7A, FIG. 7B and FIG. 7C show that the VE, CE, and EE of the cells depend on the current density during charge-discharge process. With increasing current density, the CE of VRFB increases while the VE and EE decreases. The CE of VRFB is higher because the crossover of vanadium ions is less at higher current density. Furthermore, the Nafion-g-NaSS membrane yields higher VE, CE, and EE than pristine Nafion membrane at all current densities. The higher CE suggests that vanadium ion crossover is lower in the Nafion-g-NASS membrane. Because the surface pores on the Nafion-g-NASS membrane are blocked by NASS-grafted thin layer, the VO²⁺ permeability is thus reduced.

FIG. 7B shows that VRFB/Nafion-g-NASS exhibits higher VE than VRFB/Nafion. This can be attributed to increased conductivity of the modified membrane. For an ion exchange membrane such as Nafion, the conductivity largely depends on water uptake and IEC. The grafting of NASS changes little of the water uptake of the Nafion membranes. However, the IEC of Nafion-g-NASS is higher due to the presence of NASS sulfate groups in the modified membrane. Consequently, VRFB/Nafion-g-NASS has a higher VE as compared to VRFB/Nafion at all current densities due to the lower membrane resistance of the modified membrane. Furthermore, FIG. 7B also shows that the VE is lower at higher current density. This is due to that the overpotentials and the ohmic resistances increase with current density.

FIG. 7C shows that VRFB/Nafion-g-NASS exhibits higher EE than VRFB/Nafion at all current densities. This is reasonable since EE is the product of CE and VE.

### [Performance of VRFB Single Cell-2]

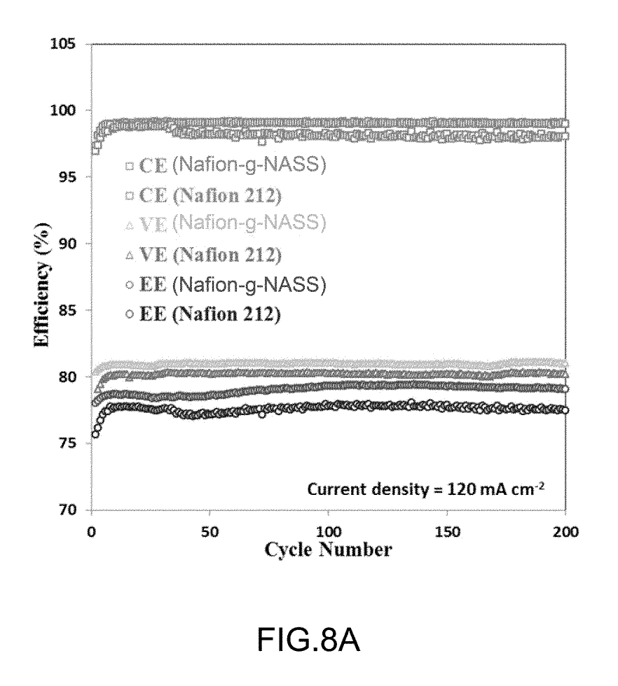

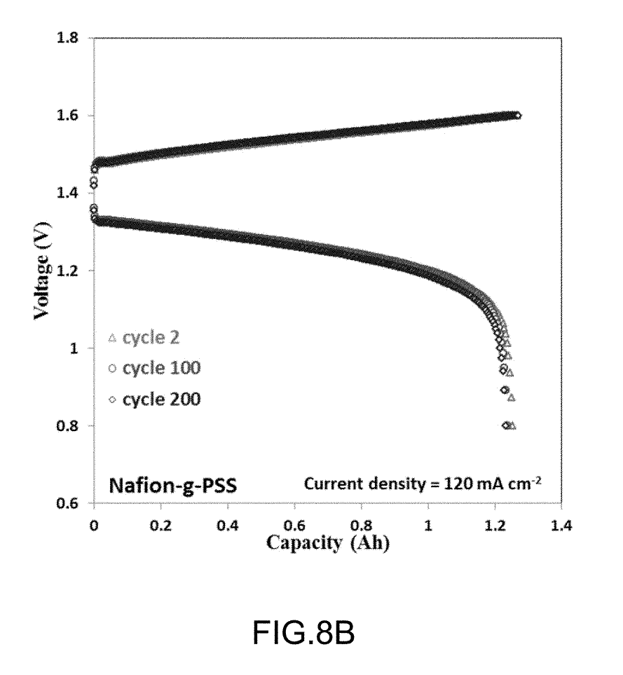

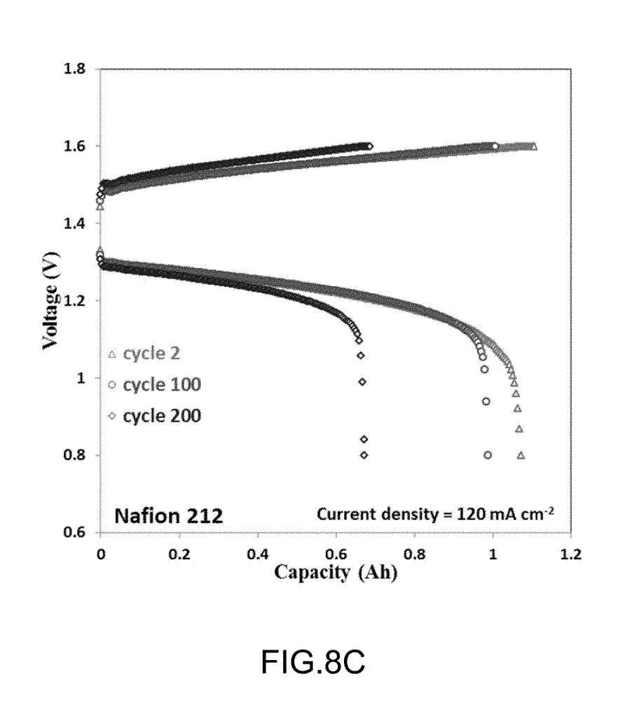

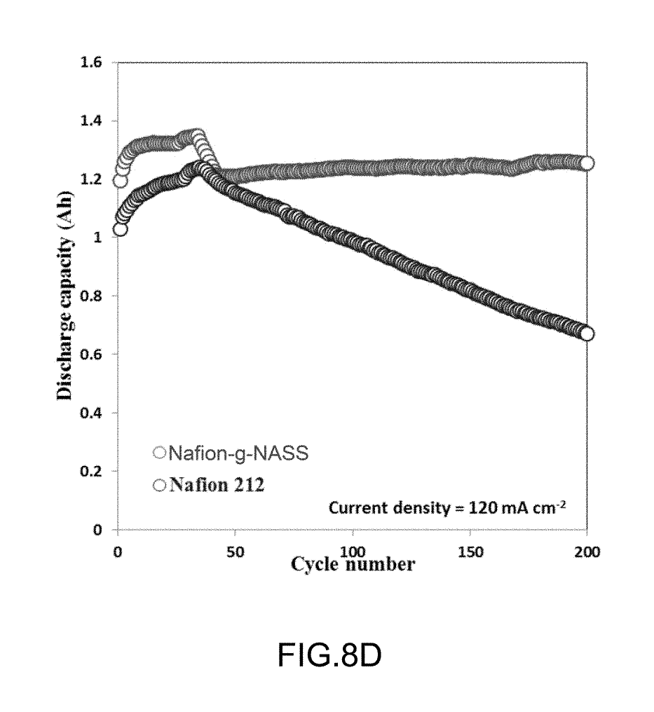

FIG. 8A depicts the efficiencies of VRFB/Nafion-g-NASS and VRFB/Nafion during the charge-discharge cycles at 120 mA·cm⁻². The CEs, VEs, and EEs of VRFB/Nafion and VRFB/Nafion-g-NASS change little in the 200 cycles, indicating the high stability of both the membranes. The efficiencies of VRFB/Nafion-g-NASS show no obvious declination after 200 cycles. The result further indicates that the Nafion-g-NASS membrane is chemically stable, enabling excellent cell performance in the strongly acidic vanadium solution.

FIG. 8B shows the charge-discharge curves of VRFB/Nafion-g-NASS at cycles 2, 100 and 200. These overlapping curves indicate that no significant capacity fading occurs after continuous running for 2, 100, and 200 cycles. In contrast, the charge-discharge curves of VRFB/Nafion are diverse, as shown in FIG. 8C. The discharge capacities of VRFB/Nafion-g-NASS and VRFB/Nafion lost 7% and 46% after 200 cycles, respectively. The capacity loss of VRFB/Nafion-g-NASS is much less than that of VRFB/Nafion. The lower capacity loss of VRFB/Nafion-g-NASS can be attributed to the lower permeability to vanadium ions as compared to the Nafion 212 membrane.

Importantly, the difference in CE between VRFB/Nafion-g-NASS and VRFB/Nafion is smaller than the difference in VE. The difference is due to the shorter permeation time for vanadium ions and lower ohmic polarization of the VRFB containing the Nafion-g-NASS membrane at higher current densities. Furthermore, the lower ohmic polarization and permeability of vanadium ions through the Nafion-g-NASS membrane also improve the discharge capacity, as shown in FIG. 8D. During the 200 cycle, the discharge capacity of the VRFB containing the Nafion-g-NASS membrane changes little, while that of VRFB/Nafion decreases with increasing cycles, eventually losing about 38% discharge capacity. In summary, the Nafion-g-NASS membrane is chemically stable in the electrolyte solutions under strongly oxidizing and acidic conditions, indicating that the modified membrane is applicable for VRFB.

From the foregoing, the surface of the Nafion 212 membrane is grafted with NASS via the oxygen-plasma-induced grafting technique. By so doing, the surface-modified membrane exhibits a permeation of vanadium ion 32% of that of the pristine Nafion 212 membrane because the surface pores of the modified membrane are blocked by grafted NASS layer. In addition, modification with NASS provides sulfate groups on the surface of the Nafion membrane, resulting in a higher IEC and greater through-plane conductivity than those of the pristine Nafion 212 membrane. Furthermore, the contact angle measurements show that the extra sulfate groups on the exposed surface make the surface hydrophilic. On using the modified membrane in a VRFB cell, the lower vanadium crossover leads to a reduction in self-discharge. The results from charge-discharge cycling at 120 mA·cm⁻² show that the CE, VE and EE of VRFB/Nafion-g-NASS are respectively 0.8%, 2%, and 2.6% higher than those of VRFB/Nafion. Moreover, no serious damage is found for the Nafion-g-NASS membrane after immersing in VO₂⁺ solution for 30 days, which suggests chemical stability. The chemical stability is also proved by the cycling in vanadium and mixed-acid solutions. Furthermore, the cycle performance of VRFB/Nafion-g-NASS remains stable accompanied with a stable efficiency and discharge capacity over 200 cycles, which attributes to the lower permeability of vanadium ions through the modified membrane. Thus, the results indicate that, by grafting NASS onto the Nafion membrane, the permeability of vanadium ions is greatly reduced, which thus improves the performance of VRFB.

Accordingly, the present invention has the following characteristics:

1. The transporting of vanadium ions is low with small cross-contamination and reduced self-discharge for improving energy efficiency.

2. The ion permeability is high with low membrane resistance and high voltage efficiency.

3. A certain mechanical strength is obtained with chemical resistance, oxidation resistance and a long life cycle.

4. Water permeability is small during charging and discharging the battery, which holds the aqueous balance of electrolytes for anode and cathode.

To sum up, the present invention is a method of fabricating a separating membrane of a flow battery for achieving low impedance and low permeability, where, through an oxygen plasma induced grafting technique, sulfonates (SO₃⁻) are grown on the surface of a Nafion membrane to increase conductivity of protons; the sulfonates obturate holes of the Nafion membrane to stop vanadium ions having a bigger size from being permeated; and the permeability of vanadium ions is thus reduced while the conductivity of protons is improved by using the modified membrane.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a separating membrane of a flow battery for achieving low impedance and low permeability, comprising steps of:
(a) Pretreatment of separating membrane: obtaining a Nafion membrane to be processed with a soaking pretreatment;
(b) Oxygen-plasma activation: activating said Nafion membrane through an oxygen-plasma treatment to obtain oxygen radicals on surface of said Nafion membrane; and
(c) Grafting of hydrophilic monomer of sodium 4-styrenesulfonate (NASS): immersing said activated Nafion membrane in a NASS monomer, wherein copolymerization is processed between said oxygen radicals and the carbon-carbon double bonds (C═C) of said NASS monomer;a hydrophilic group of sulfonates (SO₃⁻) is grown on said surface of said Nafion membrane; said sulfonates obturate holes of said Nafion membrane; and protons having a smaller size but not vanadium ions having a bigger size pass through said Nafion membrane.

2. The method according to claim 1, wherein, in step (a), said soaking pretreatment comprises steps of: (a1) immersing said Nafion membrane in hydrogen peroxide (H₂O₂) at a temperature of 65˜95 celsius degrees (° C.) for a period of 50˜70 minutes (min); (a2) immersing said Nafion membrane in deionized water at a temperature of 65˜95° C. for a period of 25-35 min; (a3) immersing said Nafion membrane in sulfuric acid (H₂SO₄) at a temperature of 65˜95° C. for a period of 25-35 min; and
(a4) washing said Nafion membrane with deionized water to remove H₂SO₄.

3. The method according to claim 1, wherein, in step (b), said oxygen-plasma treatment is processed for 5-8 min.

4. The method according to claim 1, wherein, in step (b), said oxygen-plasma treatment uses an oxygen flow with a volume fixed at 20˜30 liters per minute.

5. The method according to claim 1, wherein, in step (b), said oxygen-plasma treatment uses a wattage fixed at 50-200 watts.

6. The method according to claim 1, wherein, in step (c), said activated Nafion membrane is immersed in 5-15 weight percent of said NASS monomer at a temperature of 55˜85° C. to process said copolymerization by grafting for 20˜30 hours.
